(19) United States
(12) Patent Application Publication
(10) Pub. No.: US 2019/0179803 A1
(43) Pub. Date: Jun. 13, 2019

(54) APPARATUS AND METHOD FOR FILE SHARING BETWEEN APPLICATIONS

(71) Applicant: ELECTRONICS AND TELECOMMUNICATIONS RESEARCH INSTITUTE, Daejeon (KR)

(72) Inventors: Hyun-Hwa CHOI, Daejeon (KR); Dong-Jae KANG, Daejeon (KR); Byoung-Seob KIM, Sejong (KR); Song-Woo SOK, Daejeon (KR); Seok-Ho SON, Daejeon (KR); Myeong-Hoon OH, Daejeon (KR); Byeong-Thaek OH, Sejong (KR); Young-Woo JUNG, Daejeon (KR)

(21) Appl. No.: 16/216,401

(22) Filed: Dec. 11, 2018

(30) Foreign Application Priority Data
Dec. 11, 2017 (KR) 10-2017-0169545

(51) Int. Cl. G06F 16/176; G06F 16/18; G06F 16/188; G06F 9/455

(52) U.S. Cl. CPC G06F 16/176; G06F 16/1873; G06F 2009/45583; G06F 9/45558; G06F 2009/45579; G06F 16/196

(57) ABSTRACT

Disclosed herein are an apparatus and method for sharing a file between applications. The apparatus includes a file-mapping management unit for checking the file open mode of a file that one or more applications on respective virtual machines request to open, checking the newest version of the file, and managing a mapping relationship between the application and the data of the file; a file management unit for creating a new file as a new version of the file when the file open mode is a write mode; and a data management unit for loading the data of the new file into memory when the file open mode is a write mode, and providing the loaded data to the application, thereby sharing the file between the applications.

### CROSS REFERENCE TO RELATED APPLICATION

This application claims the benefit of Korean Patent Application No. 10-2017-0169545, filed Dec. 11, 2017, which is hereby incorporated by reference in its entirety into this application.

### BACKGROUND OF THE INVENTION

### 1. Technical Field

The present invention relates generally to technology for sharing a file between applications, and more particularly to technology for controlling and managing files between applications for reading from and writing to a file in a virtualized system.

### 2. Description of the Related Art

Recently, a cloud-computing environment is widely being used as a system for processing a large amount of data in a super multi-view video streaming service, or the like. In a super multi-view video service, super multi-view video streaming applications provide video to users by reading an index file and a super multi-view video file.

Here, an index file and a super multi-view video file are created by sequentially running an image-multiplexing application, a video encoder application, and a video indexer application. Applications for providing a super multi-view video service read file data, perform operations on the file data, and save the results of the operations as a file or provide the results to users.

Here, an application makes either a request to read from a file or a request to write to the file, and a file created in response to a request to write to the file may only be read multiple times in response to requests to read from the file (write-once read-N-times).

Here, a file that is input to an application is created by another application that is run earlier than the application. When an application that requests to write to a file is simultaneously run with an application that requests to read from the same file, an error occurs during the execution of the application that requested file input/output later than the other (that is, the application that is run later than the other), and execution of the application is suspended.

In order to solve this problem, a system administrator or an application scheduler recognizes the execution and termination of an applications and then subsequently runs the following application, thereby preventing simultaneous accesses to a file.

However, in the case of applications run by many unspecified individuals, such as super multi-view video streaming applications in a super multi-view video service and the like, it is impossible to control the execution thereof. Accordingly, when the service is upgraded or updated, the service is unavoidably interrupted and resumed in early morning hours, during which the smallest number of users access the service. In connection with this, Korean Patent Application Publication No. 10-2014-0027182 discloses a technology relate to “Storing metadata inside file to reference shared version of file”.

### SUMMARY OF THE INVENTION

An object of the present invention is to manage file versions at a virtual machine monitor level in response to a file input/output request.

Another object of the present invention is to prevent an execution error, which occurs when two applications request input/output of the same file, and to continuously provide a cloud service without interrupting the service.

A further object of the present invention is to directly manage file data using a virtual machine monitor, thereby improving file input/output performance.

Yet another object of the present invention is to enable file data to be shared without controlling reading from and writing to the same file when applications based on a large amount of data are run.

Still another object of the present invention is to enable a new version of a file to be released any time and managed.

Still another object of the present invention is to enable a cloud service to be upgraded without interrupting the service.

In order to accomplish the above objects, an apparatus for sharing a file between applications according to the present invention includes a file-mapping management unit for checking the file open mode of a file that one or more applications on respective virtual machines request to open, checking the newest version of the file, and managing a mapping relationship between the application and the data of the file, the file-mapping management unit running on a virtual machine monitor; a file management unit for creating a new file as a new version of the file when the file open mode is a write mode; and a data management unit for loading the data of the new file into available memory after the new file is created or loading the data of the newest version of the file into the memory when the file open mode is a read mode, and providing the loaded data to the application, thereby sharing the file between the applications.

Here, when the application requests to close the file, the file-mapping management unit may control the data management unit so as to store the loaded data in a storage unit and control the file management unit so as to close the new file.

Here, in the state in which the application using the file is not terminated, when another virtual machine newly runs the same application, the file-mapping management unit may check the newest version of the file and provide the data thereof.

Here, when the request to close the file is made, the file-mapping management unit may close the file, delete the mapping relationship of the file, and delete a file that is not being used, among versions of the file that are created before the closed file.

Here, when the file open mode is the read mode, the data management unit may load the data of the file into the memory, map the data to a virtual memory space, and thereby provide the data of the file.

Here, the virtual machines may run the one or more applications that perform input/output of the file based on a file interface supported by an operating system.

Here, the apparatus may receive a request for an operation for the file from the application through the file interface.

Here, when a second application on the virtual machine or on an additional virtual machine writes to the file while a first application on the virtual machine is reading from the file, the file management unit may create a new version of the file.

Here, when the first application on the virtual machine or on the additional virtual machine requests to read from the file after the second application on the virtual machine completes writing to the new version of the file, the data management unit may load the data of the new version of the file into memory.

Here, when the first application on the virtual machine requests to read from the file before the second application on the virtual machine completes the writing, the data management unit may load the data of the file into the memory.

Also, a method for sharing a file between applications, performed by an apparatus for sharing a file between applications, according to an embodiment of the present invention includes checking, by the apparatus running on a virtual machine monitor, at least one of the file open mode of a file that one or more applications on respective virtual machines request to open and the newest version of the file and managing, by the apparatus, a mapping relationship between the application and the data of the file; creating a new file as a new version of the file when the file open mode is a write mode; and loading the data of the new file into available memory after the new file is created or loading the data of the newest version of the file into the memory when the file open mode is a read mode and providing the loaded data to the application in order to share the file between the applications.

Here, the method may further include storing the loaded data in a storage unit when the application requests to close the file; and closing the new file after storing the data in the storage unit.

Here, the method may further include, in the state in which the application using the file is not terminated, when another virtual machine newly runs the same application, checking the newest version of the file; and providing data of the newest version of the file.

Here, managing the mapping relationship may include, when the request to close the file is made, deleting the mapping relationship of the file after closing the file; and deleting a file that is not being used, among versions of the file that are created before the closed file.

Here, the method may further include, when the file open mode is the read mode, loading the data of the file into memory, mapping the data to a virtual memory space, and thereby providing the data.

Here, the virtual machines may run the one or more applications that perform input/output of the file based on a file interface supported by an operating system.

Here, the method may further include receiving, by the apparatus, a request for an operation for the file from the application through the file interface.

Here, the method may further include, when a second application on the virtual machine or on an additional virtual machine writes to the file while a first application on the virtual machine is reading from the file, creating a new version of the file.

Here, the method may further include, when the first application on the virtual machine or on the additional virtual machine requests to read from the file after the second application on the virtual machine completes writing to the new version of the file, loading the data of the new version of the file into memory.

Here, the method may further include, when the first application on the virtual machine requests to read from the file before the second application on the virtual machine completes the writing, loading the data of the file into the memory.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram that shows the configuration of an apparatus for sharing a file between applications according to an embodiment of the present invention;

FIG. 2 is a flowchart for explaining a method for sharing a file between applications according to an embodiment of the present invention;

FIG. 3 is a flowchart for explaining a process in which an apparatus for sharing a file between applications according to an embodiment of the present invention processes a request from an application to read from a file;

FIG. 4 is a flowchart for explaining a process in which an apparatus for sharing a file between applications according to an embodiment of the present invention processes a request from an application to write to a file;

FIG. 5 is an exemplary view that shows a file input/output process according to a conventional art;

FIG. 6 is an exemplary view that shows a file input/output process performed by an apparatus for sharing a file between applications according to an embodiment of the present invention;

FIG. 7 is a view for explaining a file input/output operation performed by an apparatus for sharing a file between applications according to an embodiment of the present invention;

FIG. 8 is an exemplary view that shows a file interface according to an embodiment of the present invention; and

FIG. 9 is a block diagram that shows a computer system according to an embodiment of the present invention.

### DESCRIPTION OF THE PREFERRED EMBODIMENTS

Because the present invention may be variously changed and may have various embodiments, specific embodiments will be described in detail below with reference to the attached drawings.

However, it should be understood that those embodiments are not intended to limit the present invention to specific disclosure forms and that they include all changes, equivalents or modifications included in the spirit and scope of the present invention.

The terms used in the present specification are merely used to describe specific embodiments, and are not intended to limit the present invention. A singular expression includes a plural expression unless a description to the contrary is specifically pointed out in context. In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Unless differently defined, all terms used here, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

Embodiments of the present invention will be described in detail with reference to the accompanying drawings. In the following description of the present invention, the same reference numerals are used to designate the same or similar elements throughout the drawings, and repeated descriptions of the same components will be omitted.

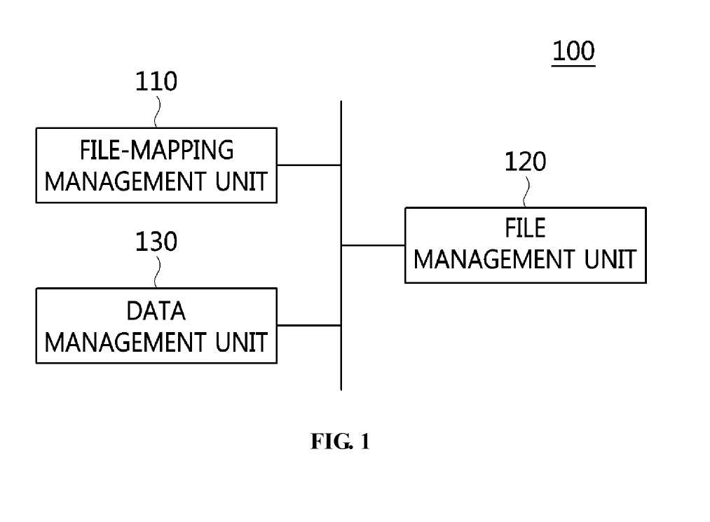

FIG. 1 is a block diagram that shows the configuration of an apparatus for sharing a file between applications according to an embodiment of the present invention.

The apparatus 100 for sharing a file between applications illustrated in FIG. 1 may operate in an environment in which physical machines with virtual machine monitors, which constitute a cloud-computing environment, are virtualized and operate as multiple virtual machines and in which applications that read from files or write to files are run on the different virtual machines.

Here, an application may either create a file with a specific file name and write thereto or read from the file with the specific file name. That is, a file is created in response to a request from an application to write to the file, and the created file may be read in response to a request from another application.

According to the conventional art, when an application that writes to a file and an application that reads from the file are simultaneously run, one of the two applications is not run because an error occurs during the execution thereof, whereby the consistency of file data may be maintained.

However, the apparatus 100 for sharing a file between applications according to an embodiment of the present invention operates through the file system interface of an Operating System (OS). Here, in response to a request to write to an existing file, the apparatus 100 for sharing a file between applications may create a new file as a new version of the file. In response to a request to read from a file, the apparatus 100 for sharing a file between applications may load the newest version of the file, among multiple versions of the file, into memory. Also, when all of the applications that requested to read the old version of the file are terminated, the apparatus 100 for sharing a file between applications may delete the corresponding old version of the file.

Accordingly, the apparatus 100 for sharing a file between applications according to an embodiment of the present invention may implement an effect in which, when multiple applications read from and write to the same file, each of the applications may input or output the file as if the application exclusively used the file without sharing the file with the remaining applications.

As illustrated in FIG. 1, the apparatus 100 for sharing a file between applications includes a file-mapping management unit 110, a file management unit 120, and a data management unit 130 on a virtual machine monitor.

First, the file-mapping management unit 110 checks the file open mode of a file that an application on each virtual machine requests to open and the newest version of the file. Also, the file-mapping management unit 110 manages the mapping relationship between the application and the data of the file.

Also, the file-mapping management unit 110 checks whether the file open mode is a read mode or a write mode in response to a file input/output request from an application. When the file open mode is a write mode, the file-mapping management unit 110 may control the file management unit 120 so as to create a new version of the target file, to load the data thereof into available memory, and to perform writing.

Conversely, when the file open mode is a read mode, the file-mapping management unit 110 may control the file management unit 120 so as to load the data of the newest version of the target file into memory and to perform reading.

When an application requests to close a file, the file-mapping management unit 110 may control the data management unit 130 so as to store the data of the new version of the file, which is loaded to the memory, in a storage unit (storage device), and may then control the file management unit 120 so as to close the new version of the file.

Also, in the state in which an application using a file is not terminated, when the same application is run by another virtual machine, the file-mapping management unit 110 checks the newest version of the file, loads the data thereof into memory, and provides the data to the application.

Also, in response to a request to close a file, the file-mapping management unit 110 may close the file, delete the mapping relationship of the file, and delete a file that is not being used, among versions of the file that are created before the closed file.

The file management unit 120 creates a new file as a new version of a file when an application requests to open the file and when the file open mode is a write mode, whereby the application that requested writing to the file may provide a service using the new file. Also, when the application requests to close the file, the file management unit 120 closes the new file under the control of the file-mapping management unit 110.

The data management unit 130 creates a new version of a file when the file is requested to be opened in a write mode, and stores data generated by the application in a storage unit (storage device) as the data of the new version of the file.

That is, when the file open mode is a write mode, the data management unit 130 creates a new file as a new version of the file and saves data written by the application in the new file. Here, only when the new file is closed may another application read from the new file. That is, while an application is writing to a file, another application is not allowed to read from the file.

The data management unit 130 loads the data of the file into memory and maps the data to a virtual memory space, thereby providing the data when the file open mode is a read mode.

Also, the data management unit 130 may store the data of the new version of the file, which is loaded into the memory, in the storage unit (storage device) under the control of the file-mapping management unit 110 when an application requests to close the file.

For example, when a second application on a first virtual machine writes to a file while a first application on the first virtual machine is reading from the same file, the file management unit 120 may create a new version of the file. Then, the file management unit 120 may enable the second application on the first virtual machine to perform a service for the data of the new version of the file.

Also, when the first application on a second virtual machine requests to read from the file after the second application on the first virtual machine completes writing to the new version of the file, the data management unit 130 may load the data of the new version of the file into memory.

Conversely, when the first application on the second virtual machine requests to read from the file before the second application on the first virtual machine completes the writing, the data management unit 130 may load the data of the file into the memory.

Here, the first virtual machine and the second virtual machine may be the same virtual machine, or may be different virtual machines.

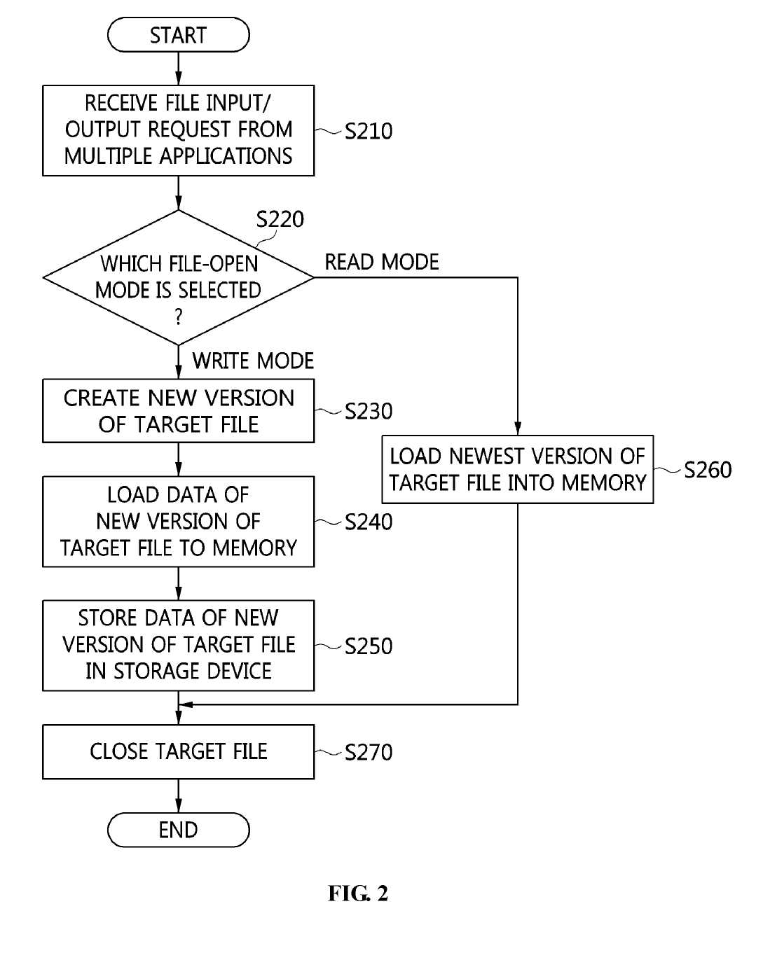

Hereinafter, a method for sharing a file between applications performed by an apparatus for sharing a file between applications according to an embodiment of the present invention will be described in more detail with reference to FIG. 2.

FIG. 2 is a flowchart for explaining a method for sharing a file between applications according to an embodiment of the present invention.

First, the apparatus 100 for sharing a file between applications receives a file input/output request from one or more applications at step S210.

Here, the file input/output request may be a request to read from a file or write to the file, and the applications may perform file input/output through a file system installed on an Operating System (OS).

Then, the apparatus 100 for sharing a file between applications checks a file open mode corresponding to the file input/output request at step S220.

When the file open mode is a write mode, the apparatus 100 for sharing a file between applications performs step S230, which will be described later, but when the file open mode is a read mode, the apparatus 100 for sharing a file between applications performs step S260, which will be described later.

When the file open mode is determined to be a write mode at step S220, the apparatus 100 for sharing a file between applications creates a new file as a new version of the target file at step S230.

After the new file is created, the apparatus 100 for sharing a file between applications loads the data thereof into available memory at step S240.

When the file open mode is a write mode, the apparatus 100 for sharing a file between applications according to an embodiment of the present invention creates a new version of the target file and loads the new version of the target file into memory, thereby enabling the application to write data to the target file.

Also, the apparatus 100 for sharing a file between applications may store the data of the new file, which is the result of processing of the file input/output request, in a storage device at step S250, and may close the target file by performing step S270, which will be described later.

Conversely, when the file open mode is determined to be a read mode at step S220, the apparatus 100 for sharing a file between applications loads the data of the target file into memory at step S260.

Finally, the apparatus 100 for sharing a file between applications closes the target file at step S270.

When it receives a request to close the file after performing step S250 or S260, the apparatus 100 for sharing a file between applications may close the file.

Here, the apparatus 100 for sharing a file between applications may delete the target file after it determines whether there is a version that is newer than the version of the target file, whether it is possible to read the newer version, and whether another application is using the target file.

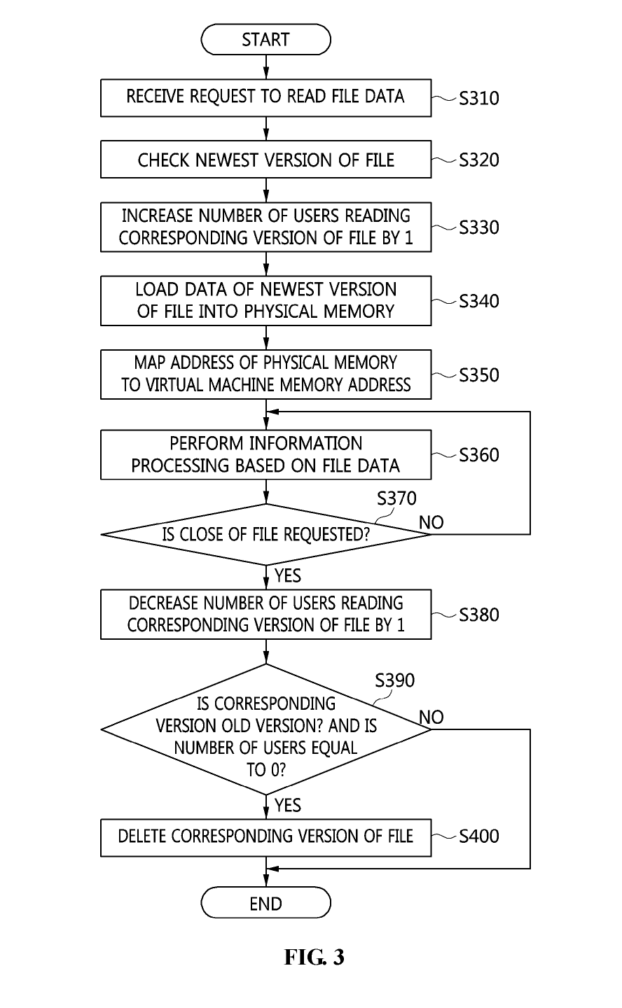

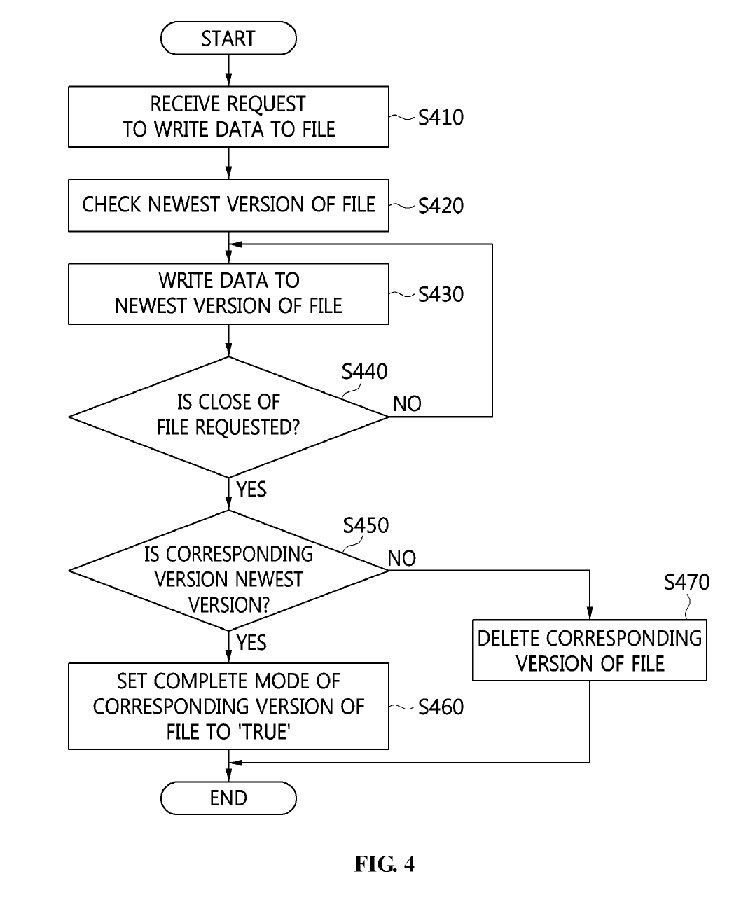

Hereinafter, a process in which an apparatus for sharing a file between applications according to an embodiment of the present invention processes a request to read from a file and a request to write to a file will be described in detail with reference to FIG. 3 and FIG. 4.

FIG. 3 is a flowchart for explaining a process in which an apparatus for sharing a file between applications according to an embodiment of the present invention processes a request from an application to read from a file.

First, the apparatus 100 for sharing a file between applications receives a request to read the data of a file at step S310.

The apparatus 100 for sharing a file between applications may receive a request to open and read a file from an application through an interface.

Then, the apparatus 100 for sharing a file between applications checks the newest version, among the available versions of the file, at step S320 and increases the number of users reading the corresponding version of the file by 1 at step S330.

Here, the apparatus 100 for sharing a file between applications checks the newest version of the file requested to be read, determines the version of the file, of which the data is to be provided to the application, and stores the mapping relationship between the application and the data of the determined version of the file.

The apparatus 100 for sharing a file between applications may check the version that is the newest among the multiple versions of the file, of which the complete mode is ‘True’, and increase the number of users reading the corresponding version of the file by 1.

Then, the apparatus 100 for sharing a file between applications loads the data of the corresponding version of the file into physical memory at step S340.

The apparatus 100 for sharing a file between applications searches for the stored mapping relationship, thereby loading the data of the corresponding version of the file into physical memory.

Also, the apparatus 100 for sharing a file between applications maps the address of the physical memory to the address of the memory of the virtual machine at step S350 and performs information processing based on the file data at step S360.

The apparatus 100 for sharing a file between applications maps the address of physical memory, at which the file data is loaded, to the address of the memory of the virtual machine on which the application is run, thereby providing the file data to the application.

Here, if the data of the corresponding version of the file is already loaded to the physical memory, the apparatus 100 for sharing a file between applications may map the address of the physical memory, at which the data is already loaded, to the address of the memory of the virtual machine.

When it receives a request to close the file (if Yes at step S730), the apparatus 100 for sharing a file between applications decreases the number of users reading the corresponding version of the file by 1 at step S380.

Then, the apparatus 100 for sharing a file between applications checks whether the corresponding version is the newest version of the file and whether the number of users reading the corresponding version of the file is equal to 0 at step S390.

When the corresponding version is not the newest version and when the number of users reading the corresponding version of the file is equal to 0 (if Yes at step S390), the apparatus 100 for sharing a file between applications closes and deletes the corresponding version of the file at step S400.

The apparatus 100 for sharing a file between applications may check whether there is the newest version, that is, a version newer than the version of the file requested to be closed, whether it is possible to read the newest version, and whether another application is using the version of the file requested to be closed.

When it is determined that it is possible to read the newest version of the file and when it is determined that there is no application using the version of the file requested to be closed, the apparatus 100 for sharing a file between applications may close and delete the corresponding version of the file.

As described above, the apparatus 100 for sharing a file between applications according to an embodiment of the present invention automatically deletes versions that are older than the newest version of the file, thereby efficiently using storage space.

Conversely, when it is determined that the corresponding version of the file is the newest version or when the number of users reading the corresponding version of the file is not equal to 0, the apparatus 100 for sharing a file between applications may close the corresponding version of the file.

FIG. 4 is a flowchart for explaining a process in which an apparatus for sharing a file between applications according to an embodiment of the present invention processes a request from an application to write to a file.

First, the apparatus 100 for sharing a file between applications receives a request to write file data at step S410.

The apparatus 100 for sharing a file between applications may receive a request to open and write to a file from an application through an interface.

Then, the apparatus 100 for sharing a file between applications creates a new file as a new version of the file at step S420 and writes data to the new file at step S430.

The apparatus 100 for sharing a file between applications checks the version of the file corresponding to the request and creates a new version of the file. Also, the apparatus 100 for sharing a file between applications may set the complete mode of the created new version of the file to ‘False’.

The apparatus 100 for sharing a file between applications may write data to the new version of the file. Also, the apparatus 100 for sharing a file between applications may store the data, which is in the physical memory mapped to the address of the memory of the virtual machine, in a storage device.

When a request to close the file is not received, the apparatus 100 for sharing a file between applications may repeat the process of performing a service using the data of the new version of the file.

When a request to close the file is received (if Yes at step S440), the apparatus 100 for sharing a file between applications checks whether the file requested to be closed is the newest version of the file at step S450.

The apparatus 100 for sharing a file between applications may close the file, and may delete the mapping relationship between the address of the virtual machine and the file. Also, the apparatus 100 for sharing a file between applications may delete all of the files that are not being used, among versions of the file that are created before the corresponding version of the file.

When the file requested to be closed is determined to be the newest version of the file (if Yes at step S450), the apparatus 100 for sharing a file between applications may set the complete mode of the file to ‘True’ at step S460. Conversely, when it is determined that the file requested to be closed is not the newest version of the file, the apparatus 100 for sharing a file between applications may delete the corresponding version of the file at step S470.

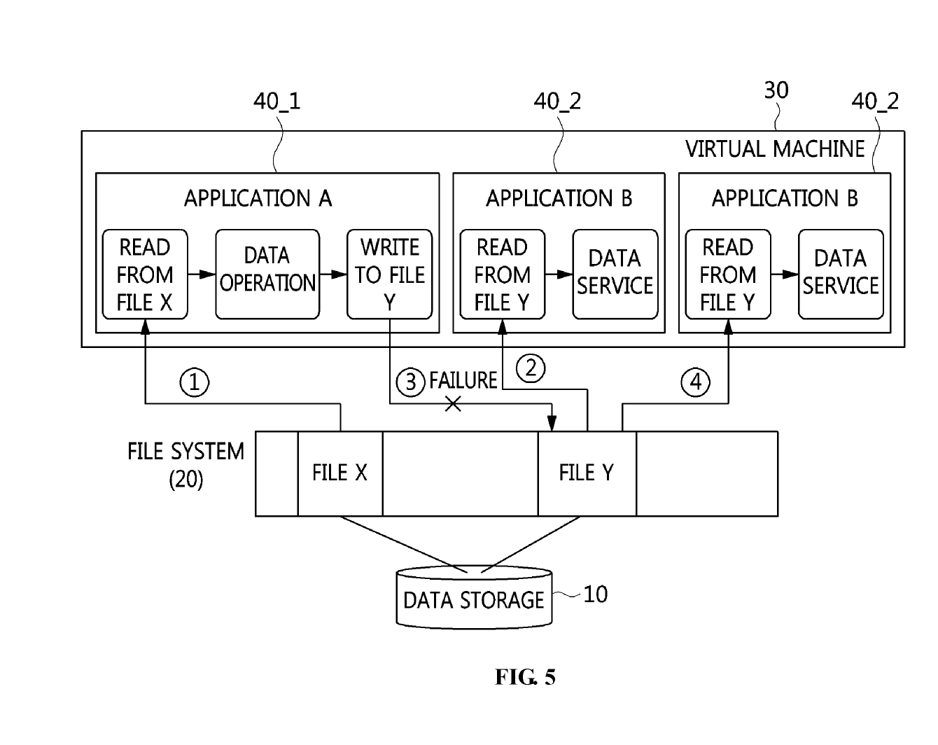

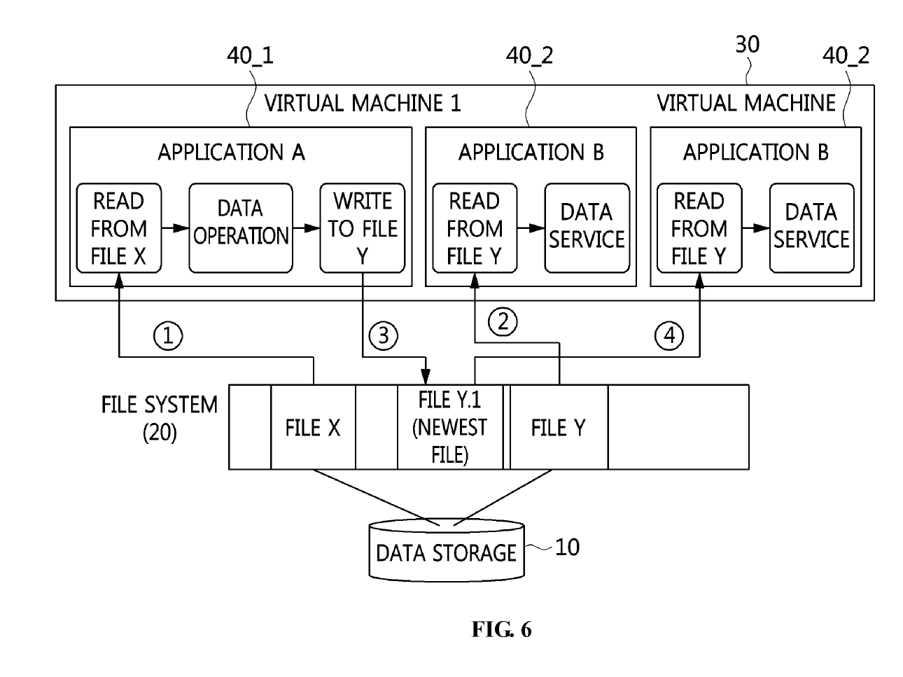

Hereinafter, a file input/output process according to an embodiment of the present invention will be described in detail in comparison with a file input/output process according to a conventional art with reference to FIG. 5 and FIG. 6.

FIG. 5 is an exemplary view that shows a file input/output process according to the conventional art.

As shown in FIG. 5, a single virtual machine is running on a single virtualized physical machine, and multiple applications that perform file input/output are running on each virtual machine. Here, the applications may perform file input/output through a file system installed on an operating system (a file interface of Linux or the like).

In the file input/output process according to the conventional art, illustrated in FIG. 5, a first application (application A) 40_1 on the virtual machine 30 may read from file X (\textcircled{1}), and a second application (application B) 40_2 on the virtual machine 30 may read from file Y (\textcircled{2}). Then, when the first application 40_1 on the virtual machine 30 requests to write to the file Y (\textcircled{3}), a run-time error occurs in the first application 40_1.

When the different applications on the virtual machine request to read from and write to the same file, because the second application 40_2, which is run earlier than the first application 40_1, requested to read from the file Y before the first application 40_1 requests to write to the file Y, a run-time error occurs in the first application 40_1.

Also, when the second application 40_2 is redundantly run (\textcircled{4}) on the virtual machine 30, the first application 40_1 on the virtual machine 30 is not able to complete writing to the file Y (\textcircled{3}) normally. That is, in the file input/output process according to the conventional art, the first application 40_1 and the second application 40_2 may not be simultaneously run.

The example in which different applications running on a single virtual machine request to read from and write to the same file has been described, but without limitation to this example, the example in which applications running on different virtual machines request to read from and write to the same file may have the same problem.

However, in the file input/output process performed by an apparatus 100 for sharing a file between applications according to an embodiment of the present invention, an application that writes to a file and an application that reads from the file may be simultaneously run.

FIG. 6 is an exemplary view that shows a file input/output process performed by an apparatus running on a virtual machine monitor for sharing a file between applications according to an embodiment of the present invention.

As illustrated in FIG. 6, assume that applications 40_1 and 40_2, which perform file input/output based on a file interface supported by an operating system, are running on a virtual machine 30.

The first application 40_1 on the virtual machine 30 reads from file X (\textcircled{1}). Also, when the second application 40_2 on the virtual machine 30 reads from file Y(\textcircled{2}), the first application 40_1 writes to the file Y (\textcircled{3}) simultaneously.

When the first application 40_1 on the virtual machine 30 requests to write to the file Y, the apparatus 100 for sharing a file between applications according to an embodiment of the present invention determines that the file Y is being used, creates file Y.1, which is a new version of the file Y, and writes data to the file Y.1.

Also, when the second application 40_2 is newly run and requests to read from the file Y (\textcircled{4}) after the first application 40_1 completes writing to the file Y.1, the apparatus 100 for sharing a file between applications according to an embodiment of the present invention loads the data of the file Y.1 (the newest version) in the file system 20 into memory, thereby enabling the second application 40_2 to perform a service using the loaded data of the file Y.1.

When the second application 40_2 requests to read from the file Y while the first application 40_1 is writing to the file Y.1, the apparatus 100 for sharing a file between applications loads the data of the file Y to memory, thereby enabling the second application 40_2 to perform a data service.

That is, the apparatus for sharing a file between applications according to an embodiment of the present invention operated on virtual machine monitor may enable an application that writes to a file and an application that reads from the same file to be simultaneously run, and may automatically provide the data of the newest version of the file.

As described above, the apparatus for sharing a file between applications according to an embodiment of the present invention may quickly process a request for file input/output on a virtual machine by implementing multiple versions of a file at the level of a virtual machine monitor, and may support sharing of the data of the newest version of a file between applications.

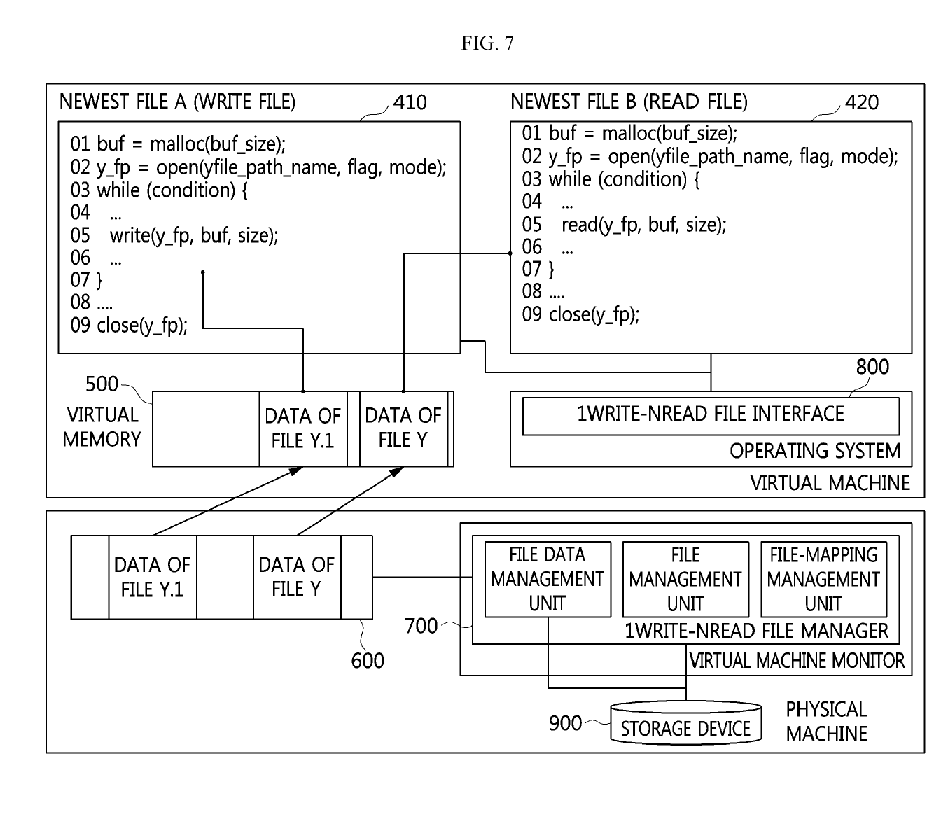

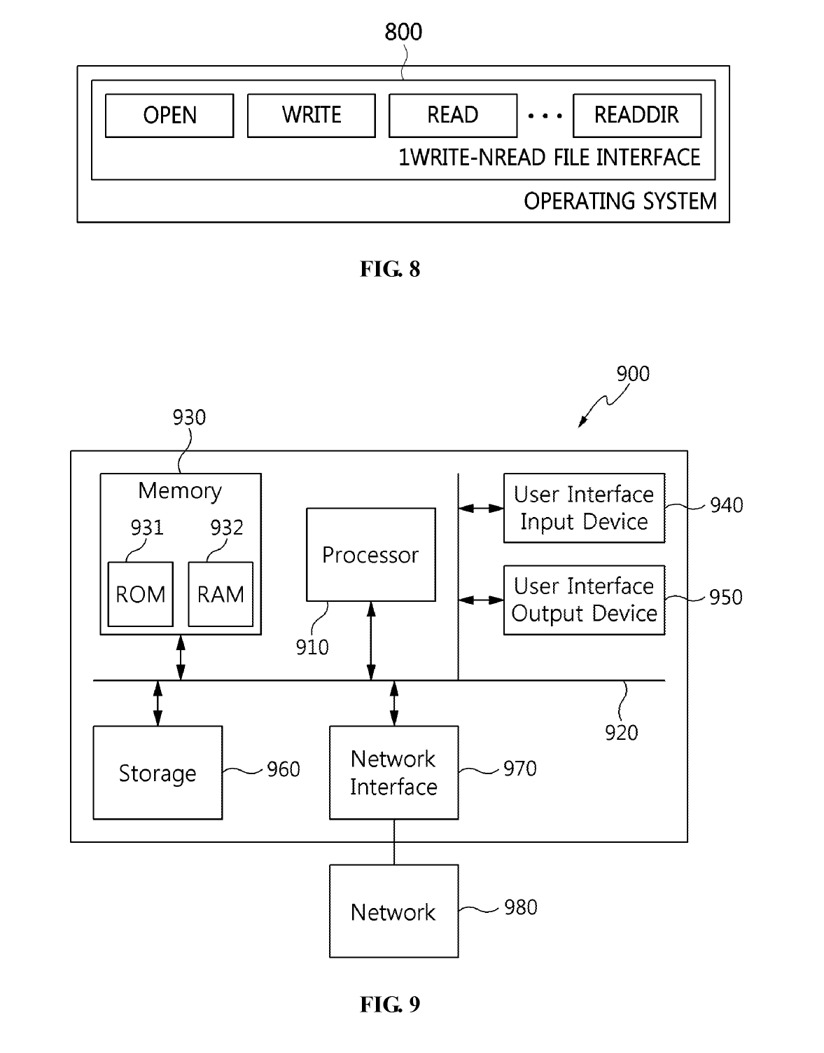

Hereinafter, a file input/output operation performed by an apparatus for sharing a file between applications according to an embodiment of the present invention will be described in detail with reference to FIG. 7 and FIG. 8.

FIG. 7 is a view for explaining a file input/output operation performed by an apparatus for sharing a file between applications according to an embodiment of the present invention, and FIG. 8 is an exemplary view that shows a file interface according to an embodiment of the present invention.

As illustrated in FIG. 7, assume that a first application (application A) 410 and a second application (application B) 420 request to read from file Y and to write to the file Y, respectively.

In the first line of the code of the application B 420, memory is allocated in order to read from the file. In the second line of the code, an open function, provided by a 1write-Nread file interface 800, is called, whereby the file-mapping management unit of a virtual machine monitor is called through a hypercall.

The file-mapping management unit checks whether the file Y is being used, and opens the file Y through the file management unit when it is determined that the file Y is not being used. When an open function is called, as shown in the second line of the code, the file data management unit that receives the request through the 1write-Nread file interface 800 loads the data of the file Y from a storage device 900 into physical memory and maps the data to a virtual memory space. Then, the application B 420 may perform information processing based on the data of the file Y, as shown in the third to seventh lines of the code.

Meanwhile, in the first line of the code of the application A 410, memory is allocated in order to write to the file. In the third line of the code, an open function, provided by the 1write-Nread file interface 800, is called.

The file-mapping management unit, called by a hypercall, checks whether the file Y is being used. Because the file Y is being used by the application B 420, the file management unit creates a file Y.1, which is a new version of the file Y.

When the application A 420 requests writing, as shown in the fourth to eighth lines of the code, the file data management unit allocates available memory and loads the data of the file Y.1 thereto. That is, the application A 420 may perform information processing based on the loaded data of the file Y.1.

Also, when a close function is called in the tenth line of the code, the file data management unit writes the data of the file Y.1 to the storage device 900, and the file management unit may close the file.

When the application B is newly run by a different virtual machine in the state in which the same application B 420 is already run and is not terminated, the file-mapping management unit checks the newest version of the file Y through the 1write-Nread file interface 800, and may provide the data of the file Y.1, which is the newest version of the file Y, to the newly run application B.

FIG. 8 illustrates a file interface including functions for opening a file (open), writing a file (write), reading a file (read), reading a directory (readdir), and the like, but the 1write-Nread file interface 800 may be variously designed depending on the interface of the file system provided by the operating system running on the virtual machine.

FIG. 9 is a block diagram that shows a computer system according to an embodiment of the present invention.

Referring to FIG. 9, an embodiment of the present invention may be implemented in a computer system 900 that includes a computer-readable recording medium. As illustrated in FIG. 9, the computer system 900 may include at least one processor 910, memory 930, a user-interface input device 940, a user-interface output device 950, and storage 960, which communicate with each other via a bus 920. Also, the computer system 900 may further include a network interface 970 connected with a network 980. The processor 910 may be a central processing unit or a semiconductor device for executing processing instructions stored in the memory 930 or the storage 960. The memory 930 and the storage 960 may be various types of volatile or nonvolatile storage media. For example, the memory may include ROM 931 or RAM 932.

Accordingly, an embodiment of the present invention may be implemented as a nonvolatile computer-readable storage medium in which methods implemented using a computer or instructions executable in a computer are recorded. When the computer-readable instructions are executed by a processor, the computer-readable instructions may perform a method according to at least one aspect of the present invention.

According to the present invention, file versions may be managed at the virtual machine monitor level in response to a file input/output request.

Also, according to the present invention, an execution error, which occurs when two applications request input/output of the same file, may be prevented, and a cloud service may be continuously provided without interruption.

Also, according to the present invention, data of a file may be directly managed using a virtual machine monitor, whereby file input/output performance may be improved.

Also, according to the present invention, when applications based on a large amount of data are run, file data may be shared without controlling reading from and writing to the same file.

Also, according to the present invention, a new version of a file may be released any time and managed.

Also, according to the present invention, a cloud service may be upgraded without interrupting the service.

As described above, the apparatus and method for sharing a file between applications according to the present invention are not limitedly applied to the configurations and operations of the above-described embodiments, but all or some of the embodiments may be selectively combined and configured, so that the embodiments may be modified in various ways.

What is claimed is:

1. An apparatus running on a virtual machine monitor for sharing a file between applications, comprising:
a file-mapping management unit for checking a file open mode of a file that one or more applications on respective virtual machines request to open, checking a newest version of the file, and managing a mapping relationship between the application and data of the file;
a file management unit for creating a new file as a new version of the file when the file open mode is a write mode; and
a data management unit for loading data of the new file into available memory after the new file is created or loading data of the newest version of the file into the memory when the file open mode is a read mode, and providing the loaded data to the application, thereby sharing the file between the applications.

2. The apparatus of claim 1, wherein, when the application requests to close the file, the file-mapping management unit controls the data management unit so as to store the loaded data in a storage unit and controls the file management unit so as to close the new file.

3. The apparatus of claim 2, wherein, in a state in which the application using the file is not terminated, when another virtual machine newly runs the same application, the file-mapping management unit checks the newest version of the file and provides data thereof.

4. The apparatus of claim 2, wherein, when the request to close the file is made, the file-mapping management unit closes the file, deletes the mapping relationship of the file, and deletes a file that is not being used, among versions of the file that are created before the closed file.

5. The apparatus of claim 1, wherein, when the file open mode is the read mode, the data management unit loads data of the file into the memory, maps the data to a virtual memory space, and thereby provides the data of the file.

6. The apparatus of claim 1, wherein the virtual machines run the one or more applications that perform input/output of the file based on a file interface supported by an operating system.

7. The apparatus of claim 6, wherein the apparatus receives a request for an operation for the file from the application through the file interface.

8. The apparatus of claim 1, wherein, when a second application on the virtual machine or on an additional virtual machine writes to the file while a first application on the virtual machine is reading from the file, the file management unit creates a new version of the file.

9. The apparatus of claim 8, wherein, when the first application on the virtual machine or on the additional virtual machine requests to read from the file after the second application on the virtual machine completes writing to the new version of the file, the data management unit loads data of the new version of the file into memory.

10. The apparatus of claim 9, wherein, when the first application on the virtual machine requests to read from the file before the second application on the virtual machine completes the writing, the data management unit loads data of the file into the memory.

11. A method for sharing a file between applications, performed by an apparatus for sharing a file between applications, comprising:
checking, by the apparatus running on a virtual machine monitor, at least one of a file open mode of a file that one or more applications on respective virtual machines request to open and a newest version of the file and managing, by the apparatus, a mapping relationship between the application and data of the file;
creating a new file as a new version of the file when the file open mode is a write mode; and
loading data of the new file into available memory after the new file is created or loading data of the newest version of the file into the memory when the file open mode is a read mode and providing the loaded data to the application in order to share the file between the applications.

12. The method of claim 11, further comprising:
storing the loaded data in a storage unit when the application requests to close the file; and
after storing the data in the storage unit, closing the new file.

13. The method of claim 12, further comprising:
in a state in which the application using the file is not terminated, when another virtual machine newly runs the same application, checking the newest version of the file; and
providing data of the newest version of the file.

14. The method of claim 12, wherein managing the mapping relationship comprises:
when the request to close the file is made, deleting the mapping relationship of the file after closing the file; and
deleting a file that is not being used, among versions of the file that are created before the closed file.

15. The method of claim 11, further comprising:
when the file open mode is the read mode, loading data of the file to memory, mapping the data to a virtual memory space, and thereby providing the data.

16. The method of claim 11, wherein the virtual machines run the one or more applications that perform input/output of the file based on a file interface supported by an operating system.

17. The method of claim 16, further comprising:
receiving, by the apparatus, a request for an operation for the file from the application through the file interface.

18. The method of claim 11, further comprising:
when a second application on the virtual machine or on an additional virtual machine writes to the file while a first application on the virtual machine is reading from the file, creating a new version of the file.

19. The method of claim 18, further comprising:
when the first application on the virtual machine or on the additional virtual machine requests to read from the file after the second application on the virtual machine completes writing to the new version of the file, loading data of the new version of the file into memory.

20. The method of claim 19, further comprising:
when the first application on the virtual machine requests to read from the file before the second application on the virtual machine completes the writing, loading data of the file into the memory.
